(19) United States
(12) Patent Application Publication
(10) Pub. No.: US 2019/0019137 A1
(43) Pub. Date: Jan. 17, 2019

(54) SYSTEMS AND METHODS FOR MAINTAINING QUALITY CONTROL BETWEEN DISTRIBUTION CENTERS AND FACILITIES

(71) Applicant: Walmart Apollo, LLC, Bentonville, AR (US)

(72) Inventors: Andrew Millhouse, Gilbert, AZ (US); John S. Meredith, Bentonville, AR (US); Leroy Ellis, Bentonville, AR (US)

(21) Appl. No.: 16/032,532

(22) Filed: Jul. 11, 2018

Related U.S. Application Data
(60) Provisional application No. 62/531,040, filed on Jul. 11, 2017.

(51) Int. Cl. G06Q 10/08; G06T 7/00

(52) U.S. Cl. CPC G06Q 10/083; G06T 2207/30128; G06T 7/0004

(57) ABSTRACT

Methods and systems for maintaining quality control for deliveries between distributions centers and facilities are discussed. The system includes a quality control application and a logistics database server. The logistics database server creates a Calgary database using invoice data. The quality control application generates a display of records retrieved from the Calgary database for determining alignment and quality control issues.

### CROSS-REFERENCE TO RELATED PATENT APPLICATIONS

This application claims priority to U.S. Provisional Application No. 62/531,040 filed on Jul. 11, 2017, the content of which is hereby incorporated by reference in its entirety.

### BACKGROUND

In the retail industry, merchandise is often shipped by truck from distribution centers or warehouses to stores, sometimes on a daily basis or other regular schedule. Frequently many distribution centers serve a large number of stores within a geographic area. Likewise, many stores may receive shipments by many different distribution centers.

### BRIEF DESCRIPTION OF THE DRAWINGS

The accompanying drawings, which are incorporated in and constitute a part of this specification, illustrate one or more embodiments of the invention and, together with the description, help to explain the invention. The drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a network environment used in an exemplary quality control system for maintaining quality control for deliveries between distribution centers and facilities, according to an embodiment;

FIG. 2 is a block diagram of an exemplary logistics database server and database suitable for use in an embodiment;

FIG. 3 displays an exemplary reference table, according to an example embodiment;

FIG. 4A is a flowchart of an exemplary method for maintaining quality control for deliveries between distribution centers and facilities, according to an example embodiment.

FIG. 4B is a flowchart of an exemplary method for maintaining quality control for deliveries between distribution centers and facilities, according to another example embodiment; and

FIG. 5 is a block diagram of an exemplary computing device suitable for use in an embodiment.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Systems and methods are described herein for a quality control system for maintaining quality control for deliveries between distribution centers and facilities. In an exemplary embodiment, the systems and methods described herein uses a high speed, large scale database such as, but not limited to, a Calgary database. In one embodiment, a logistics database server executes an extraction module to extract invoice data from a multiple invoices related to delivered items. The logistics database server also executes a creation module to create a highly indexed database using the extracted data. In the exemplary embodiment, the system includes a logistics database server executing a Calgary loader and a Calgary input tool, a Calgary database storing logistics records, and a quality control application associated with at least one facility or at least one distribution center. The logistics database server is communicatively coupled to the quality control application. The logistics database server may be configured to receive or download invoice data for one or more invoices from at least one facility and/or at least one distribution center. Each invoice may include at least a facility identifier associated with a distribution center identifier, a service type identifier, and a reference to an image file of items listed in the invoice. It will be appreciated that in an alternate embodiment the image file itself may be inserted into the database rather than a reference to the image file.

The logistics database server may be further configured to use the input tool to run SQL data calls against the invoice data in remote databases to retrieve distribution center identifiers, service type identifiers, and image file references from the invoice data. The results are transmitted to the Calgary loader to generate a Calgary database.

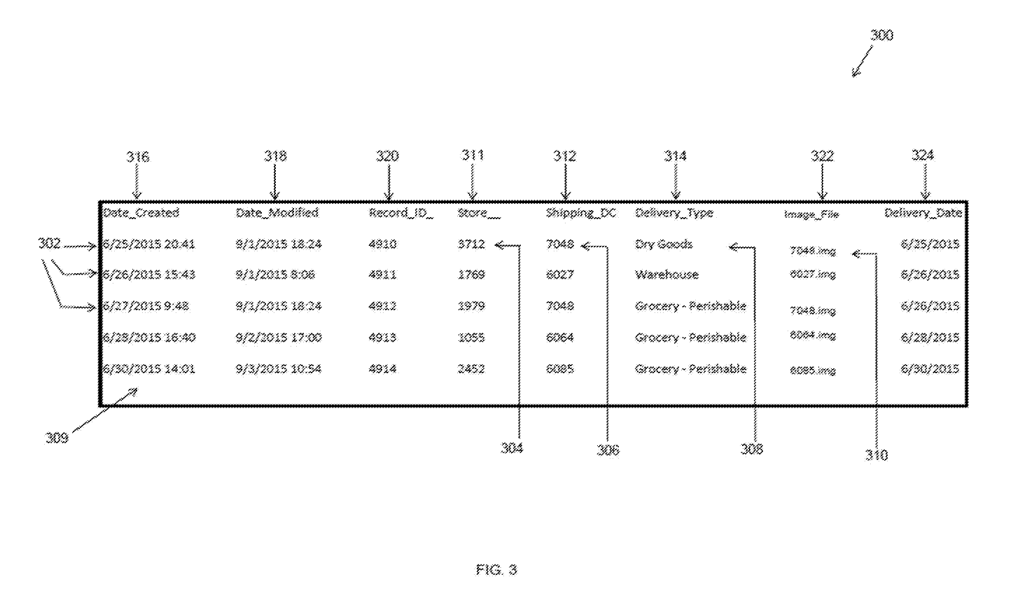

The Calgary loader creates a Calgary database that includes one or more reference tables including, but not limited to, facility identifiers, distribution center identifiers, service type identifiers, and image file references, as shown in FIG. 3. The Calgary loader forms datasets into highly indexed databases to maximize the Calgary database performance.

The logistics database server is further communicatively coupled to a quality control application. The quality control application may be installed on a remote computing device such as a desktop computer or smartphone. The quality control application transmits a records request to the logistics database server. For example, the records request may request records associated with a specific facility identifier, and the request may be transmitted by a facility associated with the facility identifier. The logistics database server queries the Calgary database using the input tool based on the records request. The logistics database server retrieves and transmits the requested records to the quality control application. The quality control application generates a display of the records to users at the requesting facility.

In additional embodiment, the Calgary database includes additional information, such as the fields shown in FIG. 3. The Calgary loader creates the Calgary database based on fields in the invoice data that a facility will want to query, which defines which fields will be indexed. For example, the invoice data may include at least the facility identifiers, the distribution center identifiers, the service type identifiers, and the image file references. The invoice data may include additional data, such as facility addresses. The facility may want the facility identifiers, distribution center identifiers, the service type identifiers, and the image file references to be a part of the output, but for this example, the facility may not want to query on facility addresses. Thus, when the Calgary database is created using the facility identifiers, distribution center identifiers, the service type identifiers, and the image file references, the facility addresses field is available yet it is not indexed, thus the field cannot be queried. If querying on an individual field or set of fields were desired, the fields are indexed.

The systems and methods described herein utilizes a large scale database such as, but not limited to, a Calgary database, and an indexing methodology to improve the speed of data retrieval operations on the database table, providing the basis for both rapid random look ups and efficient access of ordered records. Once the data is in the Calgary format, the database can be quickly queried. The resulting workflow runs in less than 1% of the time that it would if it were using standard database storage methods. Given a large amount of invoice data for many facilities and distributions center, this enables more data input (a bigger sample) and thus, better accuracy of results.

The reference table may be used, for example, by facilities for identifying distribution centers delivering freight, for example, when the distribution centers change due to events such as weather conditions. In general, such information can be used to identify what distribution centers are assigned to what facilities and efficiently realign facilities with distribution centers. The reference table may also be used to identify quality control issues based on an image file containing images of items listed in an invoice. For example, in some embodiments, one image file depicts the condition of one or more items prior to shipment from a distribution center to a facility. The facility may then identify items damaged during shipment by comparing the images displayed in the image file with the received items. In one embodiment, the damaged items may be programmatically identified by the quality control application using video analytics to compare images of the delivered items to the earlier recorded image. In another embodiment, the quality control application may generate a display of the image for manual review by an authorized individual at a receiving facility or the originating distribution center.

In some embodiments, the video analytics is performed using a video analytics computing device communicatively coupled to at least one imaging device, such as a video camera. The imaging device is configured to capture one or more images of the items prior to shipment from the distribution center to the facility and/or after shipment from the distribution center to the facility. The imaging device transmits image file(s) of the images to the video analytics computing device. The video analytics computing device receives the image file(s) depicting a condition of the items before shipment from the distribution center to the facility (the “before” images) and the image file(s) depicting a condition of the items after arrival at the facility (the “after” images). The video analytics computing device extracts image attributes from the before images and the after images in the image file(s). The video analytics computing device uses machine vision and/or video analytics to compare the attributes extracted from the before images with the attributes extracted from the after images to identify items damaged during shipment. The extracted attributes can include images of all or parts of physical items, sizes of the physical items, color of the physical items, and/or dimensions of the physical items. The types of machine vision and/or video analytics can be, but are not limited to, Stitching/Registration, Filtering, Thresholding, Pixel counting, Segmentation, Inpainting, Edge detection, Color Analysis, Blob discovery & manipulation, Neural net processing, Pattern recognition, and Barcode Data Matrix and “2D barcode” reading.

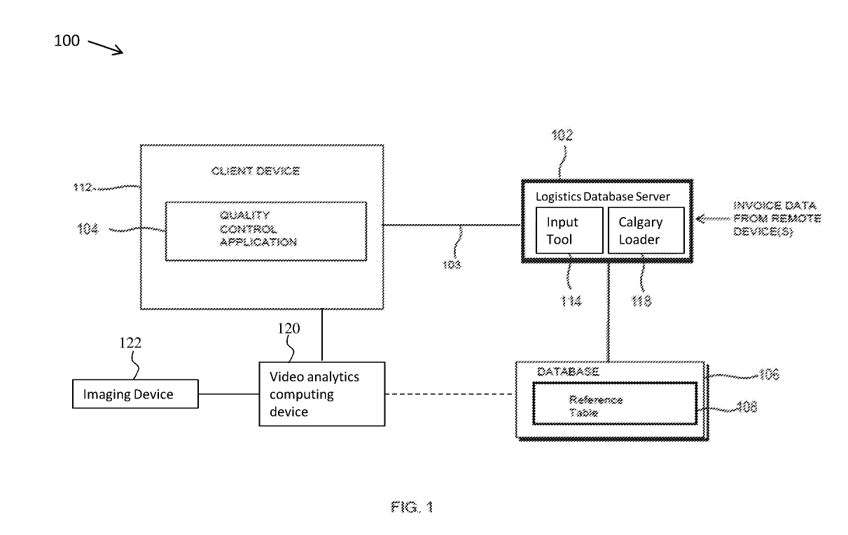

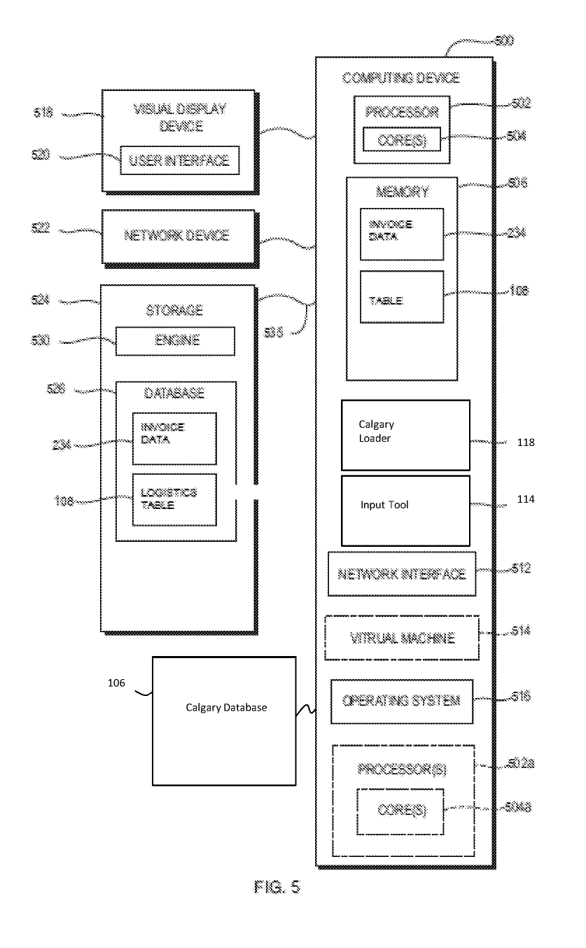

FIG. 1 is a block diagram of a network environment 100 used in the exemplary quality control system for maintaining quality control for deliveries between distribution centers and facilities, for example, freight shipped from a distribution center to a retail store. Network environment 100 includes one or more logistics database servers 102 (one shown in FIG. 1) and one or more quality control applications 104 (one shown in FIG. 1) communicatively coupled to the logistics database server 102. The logistics database server 102 may take the form of, or include, one or more computing devices that are similar to a computing device 500 illustrated in FIG. 5. The logistics database server 102 further includes an input tool 114 and a Calgary loader 118. While the Calgary database 106 has been illustrated as separate from the logistics database server 102, those skilled in the art will recognize that the Calgary database 106 may be integrated with the logistics database server 102.

The logistics database server 102 and the quality control application 104 communicates via a communication network 103. The communication network 103 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 103 are capable of supporting distributed implementations of exemplary embodiments.

In exemplary embodiments, the quality control application 104 may be installed on a client device 112 to enable users of the client device 112 to request and/or view data from one or more reference tables 108 in the Calgary database 106. The client device 112 may include, for example, a desktop computing device or a mobile computing device. The users of the client device 112 may include employees associated with a facility and/or a distribution center.

In some embodiments, the logistics database server 102 may provide the client device 112 with the quality control application 104. The quality control application 104 can be computer-readable and/or computer-executable components, such as computer-readable and/or computer-executable components for presenting a user interface. One example of the quality control application 104 provides a user interface configured to display a web page including records from a reference table 108. Another example of the application 104 and the client device 112 is a mobile application installed on a smart phone or tablet configured and/or programmed to display records retrieved from the reference table 108.

The logistics database server 102 is configured to acquire invoice data for one or more invoices from at least one facility and/or at least one distribution center. The logistics database server 102 includes an input tool 114 that when executed performs SQL data calls to extract the invoice data from the invoices. The results may be transmitted to a Calgary loader 118 to generate a Calgary database 106 including one or more reference tables 108. In some embodiments, the input tool 114 identifies invoices marked as exceptions, wherein invoice data from an excepted invoice is not inserted into the Calgary database 106. The input tool 114 further enables users to query the Calgary database.

Upon receiving a request from quality control application 104, logistics database server 102 may be configured to use the input tool 114 to query and retrieve data from the reference table 108. More specifically, the input tool 114 generates queries for the Calgary database 106 and receives responses to the queries, which includes specific records in reference table 108. The logistics database server 102 transmits the records to the quality control application 104 via network 103. The data from the reference table 108 is used for providing quality control, routing decisions between distributions centers and facilities, and the like.

In one embodiment, one or more routing decisions can be automatically calculated based on reference table 108. Logistics database server 102 may execute an alignment module to review reference table 108 to conduct alignment reviews between distribution centers and facilities. For example, in some circumstances, distribution centers may begin performing deliveries to a facility due to exceptional circumstances. However, the facility may not know the identities of the distribution centers and therefore may not be able to identify the sources of the deliveries. Logistics database server 102 may identify distribution centers that have made deliveries to a facility and then reassign the distribution centers to the facility, enabling the facility to identify distribution centers assigned to the facility and/or a distribution center that made a particular delivery. In addition, facilities may use reference table 108 to plan for the inventory needs of the stores. Reference table 108, for example, can be used by management personnel to plan activities, schedule labor resources, and to identify misalignment issues of freight.

In another embodiment, image file references 226 can be used to determine quality control issues. In one embodiment, image file references 226 indicate the location of image files containing one or more images of freight taken prior to shipment by the distribution center to the facility. The one or more images may be, for example, a JPG, a PNG and/or a BMP image file. In additional embodiments, the image file includes video. After delivery, the one or more images may be retrieved from the reference table to identify any damage to the freight occurring during shipment.

In further embodiments, the network environment 100 includes a video analytics computing device 120 communicatively coupled to at least one imaging device 122, such as a video camera. The imaging device 122 is configured to capture one or more images of items prior to shipment from the distribution center to the facility and/or after shipment from the distribution center to the facility. The imaging device 122 transmits image file(s) of the images to the video analytics computing device 120. In one embodiment, the video analytics computing device 120 receives the image file(s) depicting a condition of the items before shipment from the distribution center to the facility (the “before” images) from the imaging device 122. In another embodiment, the video analytics computing device 120 obtains the image file(s) depicting the condition of the items before shipment from the distribution center to the facility (the “before” images) from the database 106. In both embodiments, the imaging device 122 transmits to the video analytics computing device 120 image file(s) depicting a condition of the items after shipment from the distribution center to the facility (the “after” images). The video analytics computing device 120 extracts image attributes from the before images and the after images in the image file(s). The video analytics computing device 120 uses machine vision and/or video analytics to compare the attributes extracted from the before images with the attributes extracted from the after images to identify items damaged during shipment. The video analytics computing device 120 may transmit a notification to the client device 112 regarding whether damage to an item was identified based on the comparison.

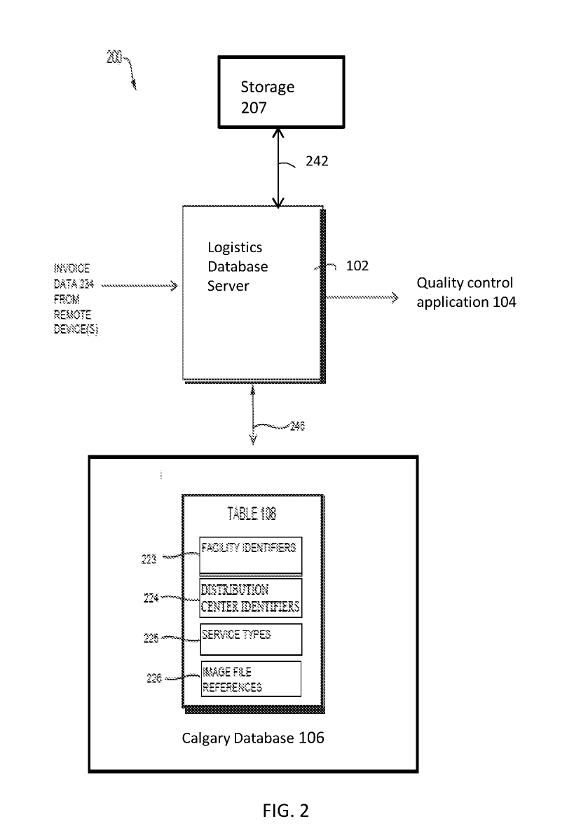

FIG. 2 is a block diagram representing an exemplary system 200 including an exemplary logistics database server 102 and a Calgary database 106 suitable for use in an embodiment. Invoice data 234 is generated when a delivery, such as freight, is shipped from a distribution center to a facility, such as a retail store. Invoice data 234 may be generated by the facility, the distribution center, or other entity responsible for the freight or delivery. Invoice data 234 includes information about the shipment, including, but not limited to, a facility identifier identifying the facility, a distribution identifier identifying the distribution center, a service type of the shipment (e.g., a grocery service type, a dry goods service type, and a warehouse service type), and at least one reference to an image file (e.g., an image file containing a pre-shipment photograph or other image of the freight). In one embodiment the invoice data may include the actual image rather than a reference to the image.

The service type of the shipment depends on items contained within the freight load. For example, a truck may be loaded with groceries and be a grocery service type. The shipments may depend, for example, on the present and/or forecast inventory needs of each store, and therefore may vary significantly from store to store. In an example embodiment, service types include a dry good service type, a grocery service type, and warehouse service type. Each distribution center is associated with a service type.

Logistics database server 102 is configured to acquire invoice data 234 from at least one facility, at least one distribution center, and/or a centralized database storing the invoice data 234. The logistics database server 102 is configured to use SQL data calls to prepare data from the invoice data 234. For examples, the SQL data calls to retrieve facility identifiers 223, distribution center identifiers 224, service types 225, and image file references 226 from invoice data 234. In some embodiments, the prepared data is placed into input files that are transmitted to the Calgary loader 118.

The Calgary loader 118 generates the Calgary database 106 after receiving the transmitted data. The facility identifiers 223, the distribution center identifiers 224, the service types 225, and the image file references 226 are indexed into one or more reference table 108 stored in the Calgary database 106. Reference table 108 may include rows and columns, as shown in FIG. 3. Each row includes at least a facility identifier 223, an associated distribution center identifier 224, an associated service type 225, and an image file reference 226.

In some embodiments, system 200 further includes a storage device 207 for storing the invoice data 234 for the facilities and/or the distribution centers. The logistics database server 102 may access storage device 207 via a communications network 242. Invoice data 234 may be transmitted to and from database 207 via communications network 246. Storage device 207 may further include information not indexed by the Calgary database 106.

FIG. 3 depicts an exemplary reference table 300 according to an example embodiment, such as reference table 108 as shown in FIG. 1. Reference table 300 may be displayed via a graphical user interface. Reference table 300 includes one or more rows 302, each row including a facility identifier 304 (shown as facility identifier 223 in FIG. 2), an associated distribution center identifier 306 (shown as distribution center 224 in FIG. 2), an associated service type 308 (shown as service type 225 in FIG. 2), and image file references 310 (shown as image file references 226 in FIG. 2). Each row corresponds to an invoice.

Reference table 300 further includes columns 309 intersecting rows 302 to define cells. Columns 309 includes at least one column including facility identifiers 311, at least one column including distribution center identifiers 312, at least one column including service type identifiers 314, and at least one column including image file references 322.

In an exemplary embodiment, reference table 300 further includes columns of dates the records were created 316, dates the records were modified 318, record identification (ID) numbers 320, and shipment delivery dates 324. In additional embodiments, reference table 300 may further include columns associated with, but not limited to, one or more of the following: trailer number, scheduled delivery arrival time, actual delivery arrival time, load quality, load rating request for contact, store type, distribution center phone number, facility phone number, distribution center phone address, facility phone address number, email addresses, comments, load quality, resolution status.

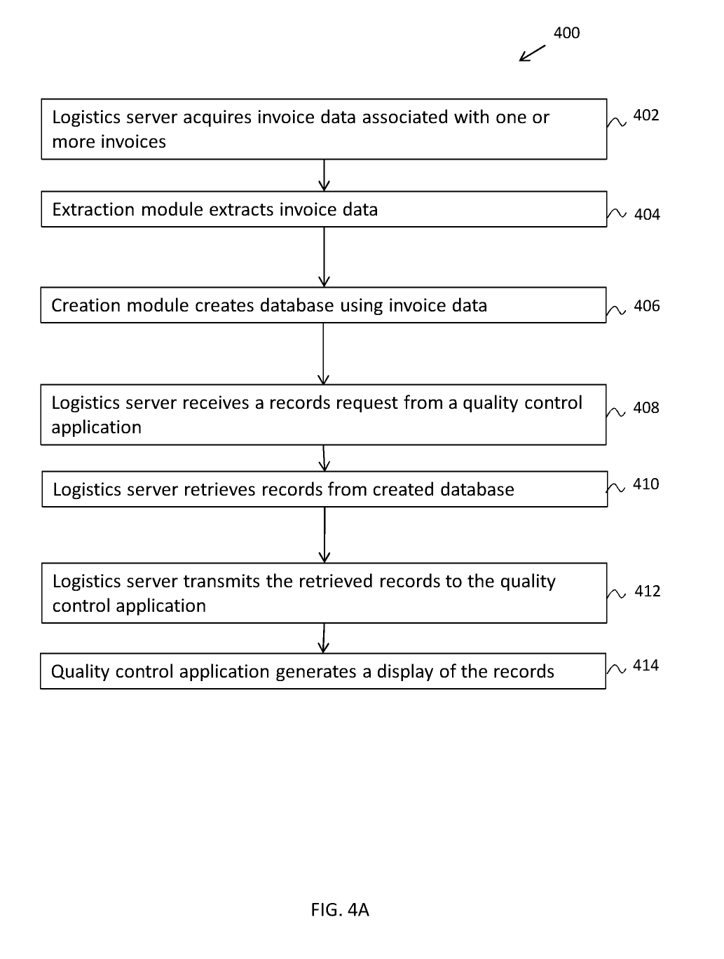

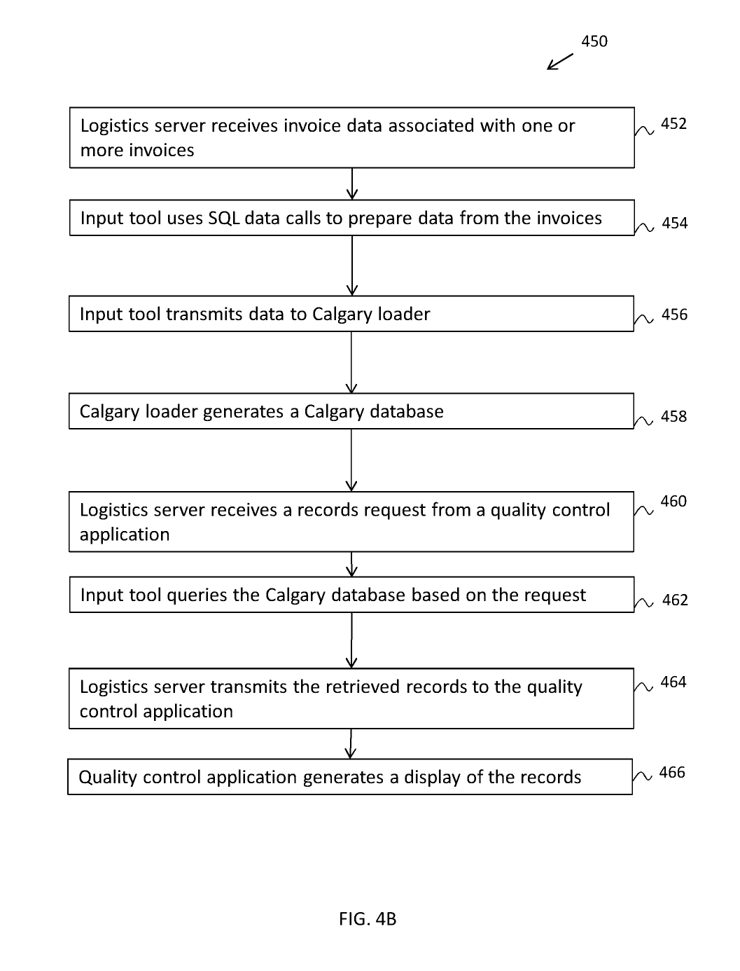

FIG. 4A depicts a flowchart of an exemplary method 400 for maintaining quality control for deliveries between distribution centers and facilities, according to an embodiment. At step 402, invoice data (shown as invoice data 234 in FIG. 2) associated with one or more invoices is received and/or downloaded by a logistics database server (shown as logistics database server 102 in FIG. 1). Each invoice is associated with a facility and a distribution center, and includes at least a facility identifier, a distribution center identifier, a service type identifier, and an image file reference.

At step 404, the logistics database server executes an extraction module, such as, but not limited to a Calgary input tool, to extract the invoice data from the invoices. More particular, the extraction module extracts a facility identifier, a distribution center identifier, a service type identifier, and an image file reference for each invoice from the invoice data.

At step 406, the logistics database server executes a creation module to generate a database using the extracted data. In one non-limiting example the database is a Calgary database.

At step 408, the quality control application (shown as quality control application 104 in FIG. 1) transmits a records request to the logistics database server. For example, the records request may request records for a specific facility identifier, and the request may be transmitted by a facility associated with the facility identifier.

At step 410, the logistics database server uses the extraction module to query the created database based on the records request, and retrieves the requested records from the created database.

At step 412, the logistics database server transmits the requested records to the quality control application.

At step 414, the quality control application generates a display of the records to users at the requesting facility. In particular, the quality control application generates a display of a distribution center identifier, a service type identifier, and a selectable reference to an image file associated one or more items in the invoice. For example, a dashboard, web page, or other graphical user interface may be rendered (e.g., via a web browser or other user interface) that may include a hyperlink to an image file. In another embodiment, the quality control application may automatically retrieve and generate a display of the images in the image file referenced by the reference table without requiring a user selection. The dashboard can be configured to display the reference table or specific data from the reference table.

FIG. 4B depicts a flowchart of a more detailed exemplary method 450 for maintaining quality control for deliveries between distribution centers and facilities, according to an embodiment. At step 452, invoice data (shown as invoice data 234 in FIG. 2) associated with one or more invoices is received and/or downloaded by a logistics database server (shown as logistics database server 102 in FIG. 1) from a remote database such as a facility or distribution center database holding invoice data. Each invoice is associated with a facility and a distribution center, and includes at least a facility identifier, a distribution center identifier, a service type identifier, and an image file reference.

At step 454, the logistics database server is further configured to use the Input tool (shown as Input tool 114 in FIG. 1) to run SQL data calls to prepare the invoice data from the invoices. More particular, the SQL calls retrieve a facility identifier, a distribution center identifier, a service type identifier, and an image file reference for each invoice from the invoice data. At step 456, the Input tool transmits the results to the Calgary loader (shown as Calgary loader 118 in FIG. 1) to generate a Calgary database.

At step 458, a Calgary loader creates a Calgary database, indexing the facility identifiers, the distribution center identifiers, the service type identifiers, and the image file reference into one or more reference tables (shown as reference table 108 in FIG. 1) stored in the Calgary database (shown as database 106 in FIG. 1). Each row of the reference table includes a facility identifier, a distribution center, a service type, and an image file reference, as shown in FIG. 3.

At step 460, the quality control application (shown as quality control application 104 in FIG. 1) transmits a records request to the logistics database server. For example, the records request may request records for a specific facility identifier, and the request may be transmitted by a facility associated with the facility identifier.

At step 462, the logistics database server queries the Calgary database based on the records request, and retrieves the requested records from the Calgary database. At step 464, the logistics database server transmits the requested records to the quality control application.

At step 466, the quality control application generates a display of the records to users at the requesting facility. In particular, the quality control application generates a display of a distribution center identifier, a service type identifier, and a selectable reference to an image file associated one or more items in the invoice. For example, a dashboard, web page, or other graphical user interface may be rendered (e.g., via a web browser or other user interface) that may include a hyperlink to an image file. In another embodiment, the quality control application may automatically retrieve and generate a display of the images in the image file referenced by the reference table without requiring a user selection. The dashboard can be configured to display the reference table or specific data from the reference table. One example of such a logistic table displayed on the dashboard is depicted and described above with respect to FIG. 3.

FIG. 5 is a block diagram of an exemplary computing device 500 suitable for use in an embodiment. In some embodiments, computing device 500 is a server, such as logistics database server 102 shown in FIG. 1. Computing device may also be a client device executing a quality control application. Computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 506 included in computing device 500 may store non-transitory computer-readable and computer-executable instructions, code, or software for implementing exemplary embodiments, such as method 400 described in FIG. 4. Computing device 500 also includes configurable and/or programmable processor 502 and associated core 504, and optionally, one or more additional configurable and/or programmable processor(s) 502a and associated core(s) 504a (for example, in the case of computer systems having multiple processors/cores), for executing non-transitory computer-readable and computer-executable instructions or software stored in memory 506 and other programs for controlling system hardware. Processor 502 and processor(s) 502a may each be a single core processor or multiple core (504 and 504a) processor. Computing device 500 further includes Input tool 114 and Calgary loader 118.

Virtualization may be employed in computing device 500 so that infrastructure and resources in the computing device may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof. Memory 506 may also store information such as invoice data 234, reference table 108, and/or other information.

A user may interact with computing device 500 through a visual display device 518, such as a computer monitor or touch screen display integrated into computing device 500, which may display one or more user interfaces 520 that may be provided in accordance with exemplary embodiments. Computing device 500 may include other I/O devices for receiving input from a user, for example, a keyboard or suitable multi-point touch interface, and a pointing device (e.g., a mouse). The keyboard and the pointing device may be coupled to the visual display device 518. Computing device 500 may include other suitable conventional I/O peripherals.

Computing device 500 may also include a Calgary database 106 and one or more storage devices 524, such as a hard-drive, CD-ROM, or other non-transitory computer-readable media, for storing data and non-transitory computer-readable instructions and/or software that implement exemplary embodiments described herein. Storage devices 524 may be integrated with computing device 500. Computing device 500 may communicate with the one or more storage devices 524 via a bus 535. Bus 535 may include parallel and/or bit serial connections, and may be wired in either a multi-drop (electrical parallel) or daisy-chain topology, or connected by switched hubs, as in the case of USB. Exemplary storage device 524 may also store one or more databases 526 for storing suitable information required to implement exemplary embodiments. For example, exemplary storage device 524 can store one or more databases 526, for storing information, such as invoice data 234, reference table 108, and/or other information. Storage device 524 can also store an engine 530 including logic and programming for performing one or more of the exemplary methods disclosed herein.

Computing device 500 can include a network interface 512 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. Network interface 512 may include a built-in network adapter, network interface card, PCMCIA network card, card bus network adapter, wireless network adapter, USB network adapter, modem or any other device suitable for interfacing computing device 500 to any type of network capable of communication and performing the operations described herein. Moreover, computing device 500 may be any computer system, such as a point of sale terminal (employee-assisted register and/or customer self-service kiosk), workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

Computing device 500 may run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, operating system 516 may be run in native mode or emulated mode. In an exemplary embodiment, operating system 516 may be run on one or more machine instances.

Having thus described several exemplary embodiments of the disclosure, it is to be appreciated various alterations, modifications, and improvements will readily occur to those skilled in the art. Accordingly, the foregoing description and drawings are by way of example only.

What is claimed is:

1. A quality control system for maintaining quality control for deliveries between distribution centers and facilities, the system comprising:
a quality control application associated with at least one facility or at least one distribution center;
a logistics database server in communication with the quality control application and that includes an extraction module and a creation module and is configured to:
acquire, over a network, invoice data for a plurality of invoices;
extract, with the extraction module, a facility identifier, a distribution center identifier, a service type identifier, and a reference to an image file displaying one or more items listed in the invoice from each invoice in the invoice data;
create, with the creation module, a database including facility identifiers, distribution center identifiers, service type identifiers, and references retrieved from the invoice data;
receive a request for records from the quality control application, the request including at least one of a facility identifier or a distribution center identifier;
retrieve the requested records from the database; and
transmit the records to the quality control application, wherein the quality control application displays at least a facility identifier, a distribution center identifier, a service type identifier, and an image file associated with the reference.

2. The quality control system of claim 1, wherein the extraction module is an input tool.

3. The quality control system of claim 1, wherein the creation module is a Calgary loader.

4. The quality control system of claim 1, wherein the database is a Calgary database.

5. The quality control system of claim 1, wherein the image file includes video.

6. The quality control system of claim 1, wherein the acquired invoice data for a plurality of invoices is for a predefined time period.

7. The quality control system of claim 1, wherein the extraction module is further configured to identify invoices marked as exceptions, wherein identifiers from an excepted invoice are not inserted into the database.

8. The quality control system of claim 1, wherein the logistics database server is further configured to reassign a distribution center to a new facility based on the database.

9. The quality control system of claim 1, wherein the service type identifiers include at least a grocery service type, a dry goods service type, and a warehouse service type.

10. The quality control system of claim 1 wherein the quality control application uses video analytics to analyze the image file for damage to the items occurring prior to delivery to a facility referenced in the invoice.

11. A method for maintaining quality control for deliveries between distribution centers and facilities, the method comprising:
acquiring, by a logistics database server that includes a extraction module and a creation module, invoice data over a network for a plurality of invoices;
extracting, with the extraction module, a facility identifier, a distribution center identifier, a service type identifier, and a reference to an image file displaying one or more items listed in the invoice from each invoice in the invoice data;
creating, with the creation module, a database including facility identifiers, distribution center identifiers, service type identifiers, and references retrieved from the invoice data;
receiving, by the logistics database server, a request for records from a quality control application associated with at least one facility or at least one distribution center, the request including at least one of a facility identifier or a distribution center identifier;
retrieving, by the logistics database server, the requested records from the database; and
transmitting, by the logistics database server, the records to the quality control application, wherein the quality control application displays at least a facility identifier, a distribution center identifier, a service type identifier, and an image file associated with the reference.

12. The method of claim 11, wherein the extraction module is an Input tool.

13. The method of claim 11, wherein the creation module is a Calgary loader.

14. The method of claim 11, wherein the database is a Calgary database.

15. The method of claim 11, wherein the image file includes video.

16. The method of claim 11, wherein the acquired invoice data for a plurality of invoices is for a predefined time period.

17. The method of claim 11, further comprising identifying, by the extraction module, invoices marked as exceptions, wherein identifiers from an excepted invoice are not inserted into the database.

18. The method of claim 11, further comprising reassigning, by the logistics database server, a distribution center to a new facility based on the database.

19. The method of claim 11, wherein the service type identifiers include at least a grocery service type, a dry goods service type, and a warehouse service type.

20. The method of claim 11, further comprising using, by the quality control application, video analytics to analyze the image file for damage to the items occurring prior to delivery to a facility referenced in the invoice.
